(19) United States
(12) Patent Application Publication
(10) Pub. No.: US 2026/0184477 A1
(43) Pub. Date: Jul. 2, 2026

(54) FLAVOR ENHANCING CONDIMENT DISPENSER

(71) Applicant: Seriously Spicy Foods LLC, Sheridan, WY (US)

(72) Inventors: Jeff Mark Lotman, Los Angeles, CA (US); Steve Fred Levit, Los Angeles, CA (US); C Jonas Kirk, Malibu, CA (US)

(21) Appl. No.: 19/008,297

(22) Filed: Jan. 2, 2025

(51) Int. Cl. B65D 47/12; B05B 7/00

(52) U.S. Cl. CPC B65D 47/12; B05B 7/00

(57) ABSTRACT

A condiment dispenser that may have (1) a primary compartment, which may include a primary dispenser, (2) a secondary compartment, which may include a secondary dispenser. Preferably, the primary compartment and secondary compartment are entirely separate within the condiment dispenser. The primary compartment is preferably on the bottom end and the secondary compartment is preferably on the top end of the condiment dispenser. The primary dispenser is preferably on a bottom part of the primary compartment. The secondary dispenser is preferably on the top part of the secondary compartment. The primary compartment and the secondary compartment preferably contain two different substances, respectively.

### FIELD

The present disclosure relates generally to food condiment dispensers, and more specifically to dual compartment condiment dispensers that allow the user to enhance the flavor or spice level of the primary condiment with a secondary condiment.

### BACKGROUND

There is a need to be able to customize condiments and snacks. Consumers often want to adjust the flavor or spice level of their food, but currently available products and packaging do not provide the flexibility to accomplish this. Instead, consumers must purchase multiple condiment variants or separate spice/flavor enhancers, which is inconvenient and inefficient.

Currently, users may use flavor packets or sachets. Specifically, some snack products come with a separate flavor or spice packet, such as may be found with instant noodles or popcorn. However, these separate packets are often messy and lack precision in adjusting the flavor/spice level.

Additionally, there exists dual-vertical-chamber condiment bottles, such as, for example, mayo and ketchup, and peanut butter and jelly. These dual-vertical-chamber condiment bottles allow a user to access and/or premix two condiments in approximately equal measure. Importantly, these dual-vertical-chamber condiment bottles do not allow a user to easily, and without a mess, adjust the flavor or spice level of the primary condiment in a dynamic way.

There also currently exists spray-based flavor enhancers, which are individual spray bottles for oils or flavor mists. However, this requires the user to purchase the product separately and they are not integrated into a main condiment or snack container.

Accordingly, there is a need in the art for a dual-compartment condiment dispenser that allows the user to adjust the flavor or spice level of the primary condiment.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

Embodiments described herein provide a condiment and snack flavor enhancement system that allows consumers to customize and adjust the flavor or spice level of their food products in real-time. The condiment dispenser of the present disclosure may be a dual-function condiment bottle or snack container that incorporates an integrated flavor or spice delivery compartment.

Some embodiments of the dispenser of the present disclosure feature a dual-compartment design. The primary compartment may be configured to contain a standard sauce, condiment, or snack and may preferably be positioned as a lower compartment. The secondary compartment may be positioned as an upper compartment and may preferably contain a flavor or spice condiment or extract.

In some embodiments the secondary compartment may have a precise delivery device, such as a spritzer, sprayer, mister, atomizer, portion-controlled pump, portion-controlled squeeze, and the like. This allows the user to add a flavoring or spice in precise amounts to the primary compartment food, or any other food or beverage, as desired by the user. When an atomizer, sprayer, or mister is employed, the substance in the secondary compartment may be accurately, precisely, and neatly directed as a stream or mist to where the user desires. If the substance in the secondary compartment is edible, such as a concentrated hot sauce, it may provide a burst of flavor to a hamburger or salad.

The primary and secondary compartments are preferably entirely separate. They may be single use, refillable, or replaceable. The substance contained may preferably be edible, but in other embodiments, the substance may be, for example, personal care products, such as lotion (primary) and fragrance (secondary), or household products, such as a cleaning solution (primary) and room scent (secondary).

In one embodiment, the secondary compartment may include an atomizer and bladder assembly, which may be attached to the primary compartment via adhesive, ultrasonic welding, threads, twist and lock, a friction snap connector, or may be an integrated unitary manufactured design. The secondary and primary compartments may preferably be interconnected, such that they are permanently interconnected. Preferably, the primary and secondary compartments may be rigid or flexible, depending on the desires of the manufacturer. In one embodiment, the primary compartment may be squeezable (and act just like a squeeze bottle) and the secondary compartment may be rigid and not substantially squeezable or deformable.

In one embodiment, the primary compartment may be a squeezable container that dispenses the substance contained within the primary compartment, such as ketchup, through a bottom, well-known drip-resistant type capped nozzle. This allows the user to de-cap the nozzle and squeeze the primary compartment to dispense the ketchup. Preferably, this capped nozzle is on the bottom of the container, which allows the ketchup to pool at the bottom, next to the nozzle for ease of dispensing. The top/secondary compartment may have an atomizer type dispenser, which operates independently from the primary compartment, allowing users to enhance their food with additional flavor or spice, as desired.

The condiment container of the present disclosure provides customization and control. The consumer has full control over the intensity and distribution of the added flavor or spice, empowering them to personalize their food experience to their taste preferences. The container of the present disclosure supports various flavor profiles, such as smoky, spicy, tangy, or sweet, making it highly versatile and suitable for a wide range of culinary applications.

The condiment container of the present disclosure provides convenience to the consumer. It combines a primary substance and a secondary flavor enhancer all in one portable and easy to use unit. This eliminates the need for a user to purchase a separate seasoning product. Further, the compact design of the container of the present disclosure makes it portable and ideal for use by consumers at home, in restaurants, or on-the-go, such as at picnics or during travel. The condiment container of the present disclosure also offers versatility because it is adaptable for a wide variety of condiments, dressings, and snacks, which increases its consumer appeal. Additionally, the container offers a customizable experience for each user. A first user might just use the container to provide the primary condiment. A second user might only use the container for the secondary flavor/spice enhancer. A third user might use both and might make their dish very spicy by pumping three or more squirts from the secondary compartment. Further, the container might allow users to vary the amount of sodium that is consumed. The primary compartment may contain popcorn that can be spritzed with salt/seasonings from the secondary compartment. A user on a low sodium diet can simply not add the salt/seasonings and can enjoy the low sodium popcorn.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a front view of one embodiment of the condiment dispenser.

FIG. 2 is an illustration of a cross-sectional view of one embodiment of the condiment dispenser.

FIG. 3 is an illustration of a cross-sectional view of another embodiment of the condiment dispenser.

FIG. 4 is an illustration of a cross-sectional view of another embodiment of the condiment dispenser.

FIG. 5 is an illustration of a cross-sectional view of another embodiment of the condiment dispenser.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

Several specific details of the invention are set forth in the following description and in the Figures to provide a thorough understanding of embodiments of the disclosure. One skilled in the art, however, will understand that the disclosure may include additional embodiments, and that other embodiments of the disclosure may be practiced without several of the specific features or processes described below.

Other aspects, as well as features and advantages of various aspects, of the present invention will become apparent to those of skill in the art through consideration of the ensuring description, the accompanying drawings and the below claims.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details.

One embodiment of the condiment container may comprise two separate compartments, one of which may include an integrated atomizer for delivering a separate liquid flavor or spice, enabling for on-the-spot customization of food products. The container may include a primary compartment for the main product/substance/condiment. The secondary compartment may be on the top and may have a top-mounted atomizer with a flexible bladder. The two compartments may be integrated as a unitary design, may be friction snaped together, or may be adhesively joined. In other embodiments the two compartments may be discrete, yet separable, such as by threads and screwing together. The primary compartment may have a dispensing nozzle, such as a standard squeeze bottle might have. This primary compartment may hold the primary condiment or product. The secondary compartment may have an atomizer and bladder that enables flavor customization.

The container of the present disclosure may have many different uses, such as a ketchup bottle with a top-mounted atomizer containing liquid chipotle essence, enabling customers to add a smoky, spicy kick to burgers or fries. Or as a snack container of popcorn with an integrated misting system for adding flavors like caramel or garlic butter, enhancing freshness and taste. Or as a mustard bottle with a stream option for adding concentrated honey for sweetness or horseradish for heat. The container of the present disclosure is integrated, precise, versatile, compact, and portable. The primary compartment may enclose such substances/condiments as (but not limited to): ketchup, mayonnaise, mustard, barbecue sauce, hot sauce, dressings, condiments, vinaigrettes, dips, humas, baba ghanoush, aioli, relish, chutney, harissa, salsa, tartar sauce, steak sauce, honey, gochujang, soy sauce, fish sauce, horseradish, gravy, jelly, nut butter, butter, oil, vinegar, chili oil, chimichurri, jam, compote, cocktail sauce, fudge, cheese, nacho cheese, caramel, hollandaise sauce, bearnaise sauce, remoulade, tahini, sour cream, créme fraiche, teriyaki sauce, marinara, velouté sauce, wasabi, frosting, icing, karo, lemon juice, miso, ponzu, peanuts, chips, popcorn, seeds, jerky, cookies, crackers, and the like. The secondary compartment may preferably have such flavors/enhancers as (but not limited to): hot sauce, concentrated hot sauce, oleoresin blends, monosodium glutamate, salt, saline, Flavacol® (butter flavored salt), capsaicin, piper nigrum, black pepper, white pepper, extracts and concentrated extracts (such as, but not limited to, vanilla, black pepper, almond, pepper, chili, capsaicin, almond, orange, and the like), bitters, vinegar, oil, butter flavoring, butter flavored oil, liquid smoke, infused flavor concentrates (natural or artificial), etc., preferably in liquid form.

The container of the present disclosure provides ease of use, such as a squeeze bottle on the bottom and simple pump atomizer or drip spout on the top. The container may be adaptable and work with a diverse array of substances, condiments, and snacks. The integrated and compact packaging may also reduce waste. In an alternative embodiment, the atomizer pump may be replaced with a fixed flow restrictor top, such as used by many types of hot sauce to allow a controlled drip, or a hearty shake. In other embodiments, the atomizer can be replaced with an eye dropper, so that the secondary flavor may be applied drop by drop onto product, which might work best for very strong and/or thicker (more viscous) flavor enhancers. In other embodiments, the bottom cap may be a hinged cap, a snap-on cap, or a threaded twist cap.

In addition to containing edible products, the container of the present disclosure may contain cosmetics or cleaning products, such as a lotion in the primary compartment and a fragrance in the secondary compartment, or such as a cleaning solution in the primary compartment and a room scent in the secondary compartment.

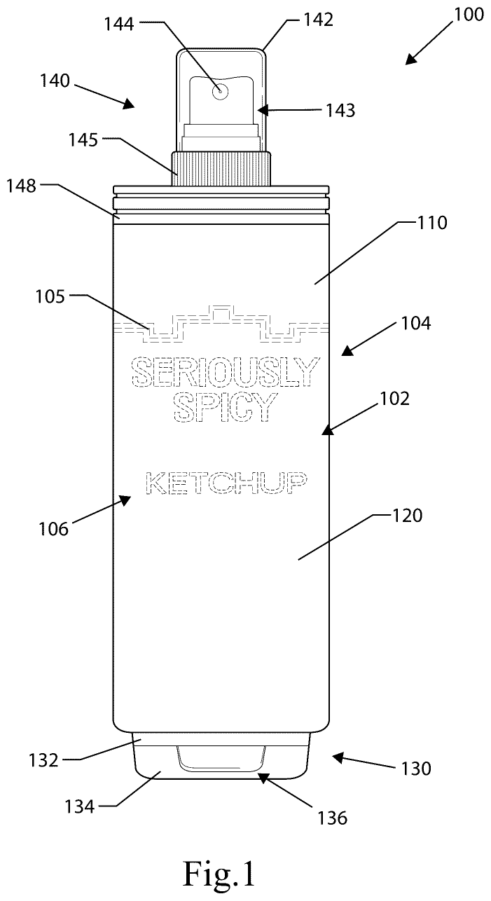

FIG. 1 is an illustration of a front view of one embodiment of the condiment dispenser. As shown in FIG. 1, dispenser 100 may comprise primary compartment 120, secondary compartment 110, label 102, branding 104, generic label 106, primary dispenser 130, and secondary dispenser 140. Preferably, primary compartment 120 and secondary compartment are entirely separate, such as by interior support joinder 105, such that the substances contained within them do not mix until they exit dispenser 100. Label 102 may be printed-on or may be a separate plastic wrap. Primary compartment 120 may preferably contain a viscous liquid condiment. In other embodiments, the contents may be a lotion or cleaning solution.

Primary dispenser 130 may be a hinged cap with a base 132, top 134 and opening dent 136. Primary dispenser 130 may be a well-known squeeze bottle type dispenser that allows the contents to be dispensed with pressure on the sides of the primary compartment 120. Preferably, primary dispenser 130 allows the user to dispense a desired amount of the contents in a controlled manner.

Secondary dispenser 140, as shown, may be a fingertip pump sprayer or atomizer that may include cap 142, outlet 144, atomizer head 143, and base 145. A spray nozzle or atomizer is a well-known device that creates a dispersion of a liquid by the formation of a spray. The pump atomizer may have a bias element that sprays the liquid out when pushed down and resets the next delivery load when the bias element pushes the atomizer head back upward. In other embodiments, the secondary dispenser 140 may be an aerosol spray dispenser, a trigger pump spray dispenser, a misting nozzle, or the like.

As shown in FIG. 1, secondary dispenser 140 may allow a user to precisely, neatly, and accurately, dispense a specific portion of the contents to where it is needed. For example, the user may add three pumps of a liquid flavoring to their snack as desired. Another user may choose to only add one pump and have less flavor, salt, or spice.

FIG. 1 shows that dispenser 100 may comprise top cap 148, which allows the user to entirely remove secondary dispenser 140 and potentially change or refill the condiment contained in secondary compartment 110.

In various embodiments, dispenser 100 may be a single use dual-compartment bottle that is recycled after a single use, or it may be reusable and/or refillable. Typically, dispenser may be made from plastic or biodegradable plastic, or it may be made out of other natural or synthetic materials, such as composites, metals, or woods.

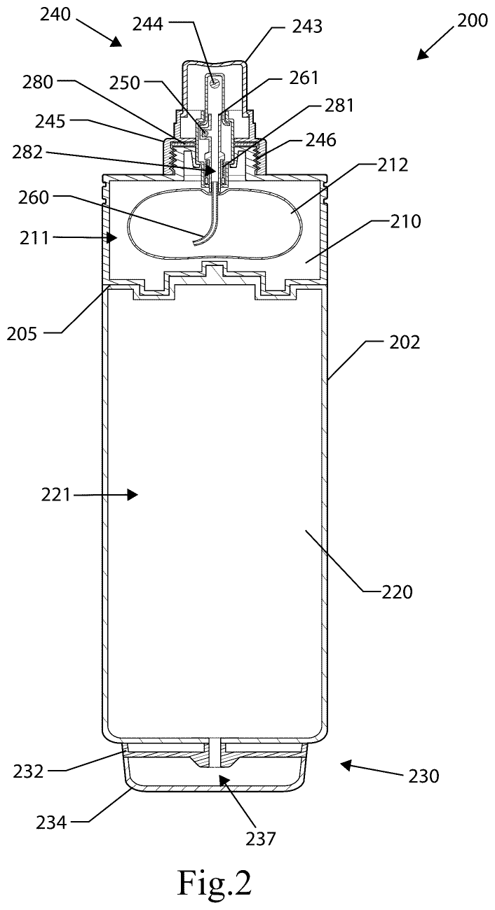

FIG. 2 is an illustration of a cross-sectional view of one embodiment of the condiment dispenser. As shown in FIG. 2, dispenser 200 may comprise primary compartment 220, secondary compartment 210, primary dispenser 230, secondary dispenser 240, and label 202. The embodiments in FIGS. 1 and 2 are substantially the same. FIG. 2 shows that the primary and secondary compartments 210, 220 are preferably two separate compartments that are interlocked together such that they are substantially fixed together permanently at joinder 205. Preferably, primary compartment 220 is a squeezable bottle that may contain approximately 3 to 30 ounces of fluid. Preferably, secondary compartment 210 may have interior bag or bladder 212 within interior space 211 that contains about 0.5 to 5 ounces of liquid.

Primary dispenser 230, which as shown is a standard nozzle for a squeeze bottle, may comprise base 232, flip cap 234, and spout 237. Primary compartment 220 is shown with interior space 221.

Secondary dispenser 240, which is shown as a fingertip pump sprayer or atomizer, may comprise outlet 244, atomizer head 243, base 245, flow restrictor 250, threading 246, piston/stem tube 261, dip tube 260, gasket 280, spring 281, and accumulator 282. The dip tube 260 and piston/stem tube 261 connect the atomizing outlet 244 and the substance contained within bladder 212 or within interior space 211. When atomizer head 243 is pushed down, liquid is sprayed from outlet 244. When atomizer head 243 moves back up via spring 281, or some other type of biasing element, the substance is pulled up from the bladder 212 or interior space 211 to accumulator 282, where it is ready to be released in the next pump. FIG. 2 shows that piston/stem tube 261 may comprise flow restrictor 250, which may be an internal ball bearing that blocks liquid from flowing through the stem tube unless the dispenser 200 is properly tilted over the food. This may prevent the secondary dispenser 240 from discharging accidentally.

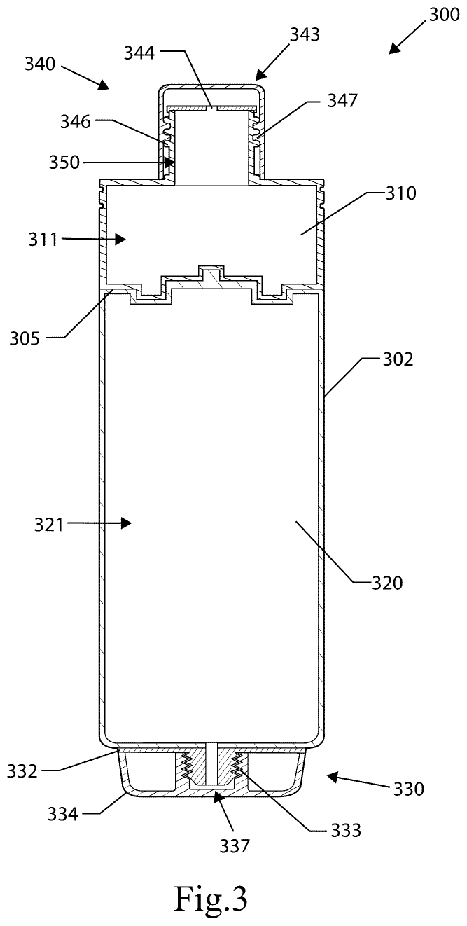

FIG. 3 is an illustration of a cross-sectional view of another embodiment of the condiment dispenser. As shown in FIG. 3, dispenser 300 may comprise primary compartment 320, secondary compartment 310, primary dispenser 330, secondary dispenser 340, and label 302. FIG. 3 shows that the primary and secondary compartments 310, 320 are preferably two separate compartments that are interlocked together such that they are substantially fixed together permanently at joinder 305. Preferably, primary compartment 320 is a squeezable bottle that may contain approximately 3 to 30 ounces of fluid. Preferably, secondary compartment 310 may have interior space 311 that contains about 0.5 to 5 ounces of liquid.

Primary dispenser 330, which as shown is a standard nozzle for a squeeze bottle, may comprise base 332, screw cap 334, threading 333, and spout 337. Primary compartment 320 is shown with interior space 321.

Secondary dispenser 340, which is shown as a standard restricted flow drip or shake spout or orifice, may comprise outlet 344, threading 346, base 350, and cap 343, which may comprise reciprocal threading 347. In this embodiment, the user may dispense the liquid/substance contained within interior space 311 a drop at a time, or a shake at a time.

In some embodiments, the primary dispenser 330 and secondary dispenser 340 are not meant to be used simultaneously, such that dispensing of contents can only be done from only one of either the primary dispenser 330 or the secondary dispenser 340. In some embodiments, mixing of materials contained with the primary and secondary compartments 310, 320 may not be possible.

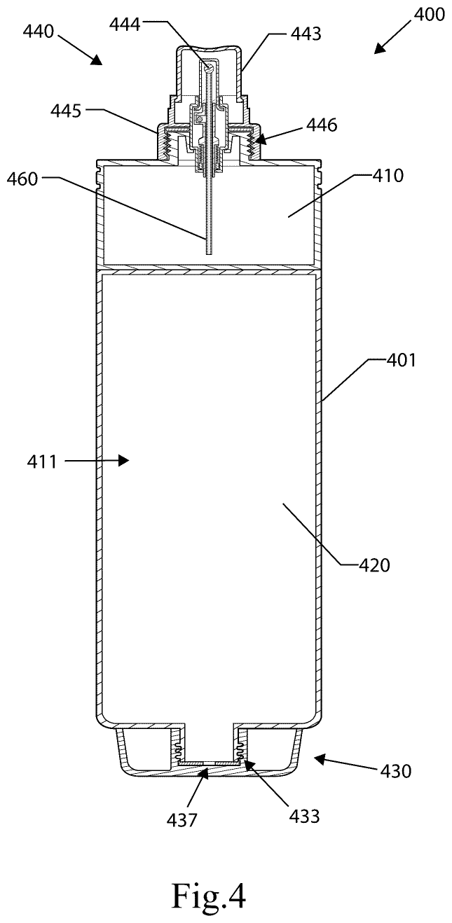

FIG. 4 is an illustration of a cross-sectional view of another embodiment of the condiment dispenser. FIG. 4 shows a unitary manufacture design of dispenser 400. As shown in FIG. 4, dispenser 400 may comprise primary compartment 420, secondary compartment 410, primary dispenser 430, and secondary dispenser 440. As shown, the primary and secondary dispensers 430, 440 are preferably on opposite ends, a top end and a bottom end, of dispenser 400. In other embodiments, the two dispensers 430, 440 may be on opposite sides rather than at the ends.

As shown in FIG. 4, primary dispenser 430 may be a flow restriction threaded cap nozzle that comprises outlet 437, threading 433, and cap 434. Preferably, primary compartment 420 may have rigid non-squeeze sides that allow the user to drip or shake the contents of interior space 411 of primary compartment 420 through outlet 437.

FIG. 4 also shows that secondary dispenser 440 may be a fingertip pump sprayer or atomizer, which may comprise outlet 444, atomizer head 443, base 445, threading 446, stem and dip tube 460. The stem and dip tube 460 may connect the atomizing outlet 444 and the substance contained within interior space 410.

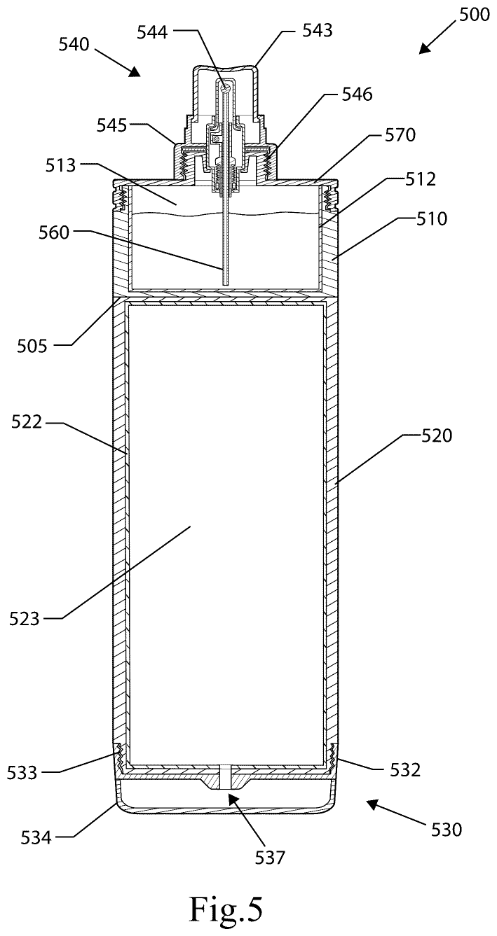

FIG. 5 is an illustration of a cross-sectional view of another embodiment of the condiment dispenser. FIG. 5 shows a renewable, separable, and/or refillable, manufacture design of dispenser 500. As shown in FIG. 5, dispenser 500 may comprise primary compartment 520, removable primary insert 522, primary compartment interior 523, secondary compartment 510, removable secondary insert 512, primary dispenser 530, and secondary dispenser 540. Preferably, removable inserts 512, 522 may be (1) refilled in position, (2) they may be removed to be refilled, and/or (3) they may be removed as single use containers, wherein a new insert is swapped in after they are removed. The removable inserts 512, 522 may be removable after dispensers 530 and 540 are removed. The two compartments 510, 520 may be separated and joined at joinder 505.

As shown in FIG. 5, primary dispenser 530 may be a standard nozzle for a squeeze bottle that comprises outlet 537, base 532, which may include threading 533, and hinged flip cap 534. Preferably, primary compartment 520 may squeezable, such that a user may, in a controlled manner, portion out the substance contained in primary compartment 520 through the outlet 537 by squeezing the side. Preferably, base 532 is removable attached to dispenser 500 by screwing and unscrewing. However, other attachment devices may be employed.

FIG. 5 also shows that secondary dispenser 540 may be a fingertip pump sprayer or atomizer, which may comprise outlet 544, atomizer head 543, base 545, threading 546, stem and dip tube 560. The stem and dip tube 560 may connect the atomizing outlet 544 and the substance contained within interior space 513. Preferably, secondary dispenser further comprises top cap 570, which is threadably and removably connected to secondary compartment 510, via unscrewing. However, other attachment devices may be employed. When top cap 570 is removed, insert 512 may be removed. Preferably, top cap 570, on its top side, threadably engages with base 545 via threading 546.

The above-detailed embodiments of the disclosure are not intended to be exhaustive or to limit the disclosure to the precise form discussed above. Specific embodiments of, and examples for the disclosure are described above for illustrative purposes, but those skilled in the relevant art will recognize that various equivalent modifications are possible without deviating from the disclosure. For example, although the above-noted steps are presented in a given order, alternative embodiments may perform the steps in a different order. Moreover, aspects of the various embodiments described herein can be combined to provide further embodiments.

Unless the context clearly requires otherwise, throughout the description and the claims, the words “comprise,” “comprising,” and the like are to be construed in an inclusive sense as opposed to an exclusive or exhaustive sense, i.e., in a sense of “including, but not limited to.” Use of the word “or” in reference to a list of items is intended to cover: (a) any of the items in the list; (b) all of the items in the list; and (c) any combination of the items in the list.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A condiment dispenser, comprising:
a primary compartment, which comprises a primary dispenser; and
a secondary compartment, which comprises a secondary dispenser;
wherein said primary compartment and said secondary compartment are entirely separate within said condiment dispenser;
wherein said primary compartment is on a bottom end of said condiment dispenser;
wherein said secondary compartment is on a top end of said condiment dispenser;
wherein said primary dispenser is on a bottom end of said primary compartment;
wherein said secondary dispenser is on a top end of said secondary compartment;
wherein said primary compartment and said secondary compartment are configured to contain two different substances, respectively; and
wherein said primary dispenser and said secondary dispenser are configured to enable a user to dispense both of said two different substances, respectively, as desired.

2. The condiment dispenser of claim 1, wherein said primary compartment is squeezable and wherein said primary dispenser is a squeeze bottle nozzle.

3. The condiment dispenser of claim 1, wherein said secondary dispenser is a fingertip pump sprayer.

4. The condiment dispenser of claim 1, wherein said secondary dispenser is a restricted flow drip spout.

5. The condiment dispenser of claim 1, wherein said primary compartment further comprises a primary insert that is configured to be removable from said primary compartment.

6. The condiment dispenser of claim 5, wherein said primary insert is configured to be refilled and then reinserted into said primary compartment.

7. The condiment dispenser of claim 5, wherein said primary insert is configured to be replaced with a second and pre-filled primary insert.

8. The condiment dispenser of claim 1, wherein said primary compartment further comprises a secondary insert that is configured to be removable from said secondary compartment.

9. The condiment dispenser of claim 8, wherein said secondary insert is configured to be refilled and then reinserted into said secondary compartment.

10. The condiment dispenser of claim 8, wherein said secondary insert is configured to be replaced with a second and pre-filled secondary insert.

11. The condiment dispenser of claim 1, wherein said primary compartment and said secondary compartment are each configured to contain a different edible condiment.

12. The condiment dispenser of claim 1, wherein said primary compartment and said secondary compartment are each configured to contain a different personal care product.

13. The condiment dispenser of claim 1, wherein said primary compartment and said secondary compartment are each configured to contain a different household product.

14. A condiment dispenser, comprising:
a primary compartment, which comprises a primary dispenser; and
a secondary compartment, which comprises a secondary dispenser;
wherein said primary compartment and said secondary compartment are entirely separate within said condiment dispenser;
wherein said primary compartment is on a bottom end of said condiment dispenser;
wherein said secondary compartment is on a top end of said condiment dispenser;
wherein said primary dispenser is on a bottom end of said primary compartment;
wherein said secondary dispenser is on a top end of said secondary compartment;
wherein said primary compartment and said secondary compartment are configured to contain two different substances, respectively;
wherein said primary dispenser and said secondary dispenser are configured to enable a user to dispense both of said two different substances, respectively, as desired;
wherein said primary compartment is squeezable and wherein said primary dispenser is a squeeze bottle nozzle; and
wherein said secondary dispenser is a fingertip pump sprayer.

15. The condiment dispenser of claim 14, wherein said primary compartment further comprises a primary insert that is configured to be removable from said primary compartment.

16. The condiment dispenser of claim 15, wherein said primary insert is configured to be refilled and then reinserted into said primary compartment.

17. The condiment dispenser of claim 15, wherein said primary insert is configured to be replaced with a second and pre-filled primary insert.

18. The condiment dispenser of claim 14, wherein said primary compartment further comprises a secondary insert that is configured to be removable from said secondary compartment.

19. The condiment dispenser of claim 18, wherein said secondary insert is configured to be refilled and then reinserted into said secondary compartment.

20. The condiment dispenser of claim 18, wherein said secondary insert is configured to be replaced with a second and pre-filled secondary insert.
